(19) United States
(12) Patent Application Publication
(10) Pub. No.: US 2021/0055570 A1
(43) Pub. Date: Feb. 25, 2021

(54) SPECTACLES

(71) Applicant: Michael Pachleitner Group GmbH, Graz (AT)

(72) Inventor: Stefano Barizza, Graz (AT)

(73) Assignee: Michael Pachleitner Group GmbH, Graz (AT)

(21) Appl. No.: 16/997,608

(22) Filed: Aug. 19, 2020

(30) Foreign Application Priority Data
Aug. 20, 2019 (EP) 19192446.3

(51) Int. Cl. G02C 5/00; G02C 5/12

(52) U.S. Cl. CPC G02C 5/008; G02C 2200/08; G02C 5/12

(57) ABSTRACT

Spectacles (1), comprising at least one spectacle lens (10) with a left and a right spectacle lens section (11, 12), a frame means (20) which comprises a left and a right frame part (21, 22) and is in mechanical engagement with the at least one spectacle lens (10), wherein each frame part (21, 22) has a fastening section (210, 220) with a fastening recess (24, 25), into which fastening recess (24, 25) at least one keying portion (13, 130, 14, 140) engages, wherein each frame part (21, 22) has a respective elastically flexible damping element (211, 221) which is fastened to a respective fastening section (210, 220), can be deflected elastically in at least one direction (R1, R2) and extends in the nasal direction (N1, N2) of the spectacles (1) along a lower edge (111, 121) of the respective spectacle lens section (11, 12) and is also separated from the lower edge (111, 121) with the formation of a variable clearance gap (S1, S2) up to a nasal end (212, 222) of the frame, wherein a respective nose pad (23) is disposed on each of the nasal frame ends (212, 222).

### BACKGROUND OF THE INVENTION

The present invention relates to spectacles comprising, at least one spectacle lens with a left and a right spectacle lens section, a frame means which comprises a left and a right frame part, wherein the frame means is in mechanical engagement with the at least one spectacle lens and the left frame part is associated with the left spectacle lens section and also the right frame part is associated with the right spectacle lens section, wherein each frame part has a fastening section with a fastening recess, into which fastening recess at least one keying portion disposed at a lateral end of the respective spectacle lens section engages.

### SUMMARY OF THE INVENTION

Many types of spectacles are known in the prior art in which individual frame parts and—depending on the design—either a continuous one-piece spectacle lens or else two separate spectacle lenses—can be mechanically assembled. This has the advantage that in the event of damage of the spectacle lens and/or frame part, the respective individual parts of the spectacles can easily and inexpensively be replaced. This is advantageous, particularly in the case of sport spectacles, because of the large mechanical stresses placed upon them when a user wears them during sporting activity. Moreover, spectacle parts which can be connected together by push fitting to form spectacles by anyone without any special tools, can be adapted to current designs and/or colours particularly easily.

As an example, document EP2159623 B1 discloses sport spectacles with a continuous spectacle lens in which a pair of elastically deformable left and right frame parts together with the sides disposed on them can be fastened to the spectacle lens by means of a plug-in connector. The nose pads are fastened directly in a nose recess of the spectacle lens on the underside of the spectacle lens.

A low weight and the associated feeling of comfort when worn are generally considered to be important criteria for spectacles, in particular sport spectacles. Spectacles should never become uncomfortable when worn for long periods.

The disadvantage with the sport spectacles design known from EP2159623 B1 and from currently known sport spectacles is at least that when an external force is applied to the spectacles, for example upon an impact or vibrations or jerking movements during sporting activity carried out by the wearer of the spectacles, the entire unattenuated weight of the spectacles is applied to the nose pads and therefore to the nose of the wearer of the spectacles. When spectacles are worn for long periods during physical activity or when carrying out sporting activities, this usually results in fatigue and pressure points in the region of the nose pads; the user of the spectacles finds this unpleasant.

The objective of the present invention is to provide improved spectacles which overcome the disadvantages of spectacles which are known in the prior art, in particular of sport spectacles, and which guarantees increased comfort during wear as well as longer, pain-free wearing of the spectacles even when the user or wearer of the spectacles is carrying out physical activity.

This objective is achieved in spectacles of the type described by means of the features defined in the characterizing portion of claim 1. Particularly advantageous, preferred embodiments and variations of the invention are defined in the dependent claims.

Spectacles in accordance with the invention comprise at least one spectacle lens with a left and a right spectacle lens section, a frame means which comprises a left and a right frame part, wherein the frame means is in mechanical engagement with the at least one spectacle lens and the left frame part is associated with the left spectacle lens section and also the right frame part is associated with the right spectacle lens section, wherein each frame part has a fastening section with a fastening recess, into which fastening recess at least one keying portion disposed at a lateral end of the respective spectacle lens section engages, wherein each frame part has a respective elastically flexible damping element, wherein each damping element is fastened to a respective fastening section and extends in the nasal direction of the spectacles along a lower edge of the respective spectacle lens section and is also separated from the lower edge with the formation of a variable clearance gap, up to a nasal end of the frame, wherein each damping element can be elastically flexibly deflected in at least one direction, and wherein a respective nose pad is disposed on each of the nasal frame ends, the nose pad being configured to sit on the nose of a user in a wearing position of the spectacles and to support the respective frame part.

In general, the terms used below regarding a location or an orientation, such as “horizontal”, “vertical”, “in the horizontal direction”, “in the vertical direction”, “over”, “under”, “in front of”, “below”, “over”, etc., are used for simplification only and these terms may possibly refer to the view in the drawings, but not necessarily to an actual position of use or wearing position of the spectacles.

In addition, anatomical positional and orientational descriptions used in the present application are used solely to simplify the description of the wearing position of the spectacles in accordance with the invention in its intended position on the front of the head of a user or spectacle wearer. Thus, the term “nasal” direction generally means “towards the nose”, i.e. medially towards the nose located centrally on the head. The term “temple” direction in general means in the direction towards the temples, i.e. to the side or laterally of the head. An “upper” or superior direction in general means pointing upwards and a “lower” or inferior direction in general means pointing downwards.

Depending on the embodiment of the spectacles in accordance with the invention, this at least one spectacle lens has a left and a right spectacle lens section. The term “spectacle lens” also encompasses one or more spectacle glazes which, for example, is or are produced from an unbreakable, transparent plastic. In an alternative embodiment, instead of a continuous spectacle lens or a continuous spectacle glaze, the spectacles may also have two mutually separate spectacle lenses. The term “a left and a right spectacle lens section” when used below therefore equally refers to sections of a one-piece spectacle lens or a one-piece spectacle glaze as well as to a left or a separate right spectacle lens in the case of an embodiment of spectacles with two mutually separated spectacle lenses. This is well known to the person skilled in the art in the spectacles field.

Normally, in spectacles, the individual left or right components such as frame parts or spectacle side pieces are generally produced in respective mirror-symmetrical pairs. Furthermore, in optical spectacles, the left and the right spectacle lens section or in an embodiment with two mutually separate spectacle lenses, the left and the right spectacle lens may, for example have optical lenses which differ from one another with the same or different optical strengths so that individual visual impairments of the user can be corrected. This is also well known to the person skilled in the art.

Furthermore, the spectacles in accordance with the invention have a frame means which comprises a left and a right frame part, wherein the frame means is in mechanical engagement with the at least one spectacle lens and the left frame part is associated with the left spectacle lens section and also the right frame part is associated with the right spectacle lens section. Depending on the embodiment, the left and the right frame part may each be in one piece or in multiple pieces. As an example, a left and a right spectacle side piece may be rigidly fastened, resiliently flexibly fastened or movably articulated by means of appropriate side hinges to the respective corresponding frame part. Similarly, spectacle side pieces may be fastened to the respective frame parts of the spectacles as separate components. As an example, the spectacle side piece may be fastened to the respective associated frame part by means of an articulated connection which is known per se in the form of a side hinge with the aid of a screw, a pin or a link pin. Similarly, in spectacles in accordance with the invention, a frame means may be provided in which the left and the right frame part are connected together. As an example, to this end, at least one nose bridge and/or a connecting bridge along the upper edge of the at least one spectacle lens may serve to connect the left and right frame part. All of these different embodiments are encompassed by the present invention.

In accordance with the invention, each frame part has a fastening section with a fastening recess, into which fastening recess at least one keying portion disposed at a lateral end of the respective spectacle lens section engages. Advantageously, the at least one spectacle lens may be mechanically connected to each frame part and also can be separated again. Depending on the embodiment, to this end, releasable interlocking and/or frictional connections may be used in order to releasably connect one or more keying portions to the lateral end of the respective spectacle lens sections or the respective separate two spectacle lenses with the respectively corresponding frame part. As an example, such releasable fastenings for fastening the at least one spectacle lens to the respective frame part may be configured as a tongue-and-groove joint, a feather-key joint, a dovetail joint, a push fit connection, a screw connection or a clamp connection.

In spectacles in accordance with the invention, each frame part respectively has an elastically flexible damping element, wherein each damping element is fastened to a respective fastening section of the respective frame part and extends in the nasal direction of the spectacles along a lower edge of the respective spectacle lens section as well as from this lower edge with the formation of a variable clearance gap, up to a nasal end of the frame, wherein each damping element can be elastically flexibly deflected in at least one direction, and wherein a respective nose pad is disposed on each of the nasal frame ends, which nose pad being configured such that in the wearing position, the spectacles sit on the nose of a user and support the respective frame part.

As a substantial advantage of the spectacles in accordance with the invention, the damping elements provide for particularly effective and comfortable damping of the spectacles against vibrations which often occur, in particular in sports such as mountain biking, running or skiing. A further advantage is that the freely swinging damping elements, which act as connecting elements between the fastening section of each frame part, which is respectively connected to the spectacle lens, and the nose pads, allow for particularly flexible, individually tailorable fixing and orientation of the nose pads and thus of the spectacles as a whole in the wearing position on the respective user's nose. Unpleasant pressure points from the nose pads, which until now have inevitably occurred when spectacles are worn for lengthy periods, in particular sport spectacles during sporting activities, can now be prevented in a particularly effective manner.

Each damping element is separated from the lower edge or from the lower contour line of the at least one spectacle lens with the formation of a variable clearance gap. Even the nasal frame ends as well as the nose pads are separated from at least one spectacle lens and are not directly connected to the spectacle lens or to the spectacle glaze. In this manner, advantageously, the respective damping element and the spectacle lens can vibrate independently of each other as well as relative to each other in order to efficiently dissipate and absorb the forces which arise during an impact or during abrupt movements when wearing the spectacles. Advantageously, the nose pads are produced from a particularly skin-friendly, slip-resistant material and are configured in a manner such that they can be tailored to the respective individual anatomy of the user's nose, for example by means of appropriate shaped inserts.

The damping elements substantially increase the wearing comfort of the spectacles; in particular, during abrupt movements or shaking movements, the at least one spectacle lens of the spectacles can swing in the vertical direction—starting from the wearing position of the spectacles-, whereupon the pressure is taken up by or cushioned by the nose pads.

Depending on the embodiment, in spectacles in accordance with the invention, the damping elements may be connected as one piece with the fastening section of the respective frame part which is adjacent to one of its ends and to which the damping elements are fastened. As an alternative to this, the damping elements may also be installed as connecting elements between the fastening section of each frame part and the nasal frame end or the nose pads as a single discrete component and, for example, be produced from a material which is different from that of the adjacent parts of each frame part. As an example, in the context of the invention, the damping elements may also be produced as discrete components from a particularly flexible material with a high dynamic strength or fatigue strength than the parts of each frame part which are adjacent to it.

The freely swinging damping elements are thus advantageously fastened at only one of its ends to the respective fastening section of the respective frame part. At its opposite other end in the longitudinal direction of the damping element which in the wearing position on the head of a user of the spectacles is respectively inwardly towards the nose of the spectacles wearer, the freely swinging nose pads are provided on the nasal frame ends. Because of the free positioning of the damping elements as well as the nose pads of the at least one spectacle lens fastened to them, the damping elements together with the nose pads can swing freely relative to the spectacle lens and in this manner, can cushion and absorb knocks and abrupt movements during wear in a particularly effective manner.

Particularly advantageously, in spectacles in accordance with the invention, the spectacle lens may be produced in one piece, wherein the left and the right spectacle lens section are connected together. This variational embodiment has the particular advantage for sport spectacles that the spectacles are particularly robust in construction because of the one-piece spectacle lens. A further advantage of such an embodiment with a one-piece spectacle lens is that the field of vision of the user is not compromised because of the continuous glazing. Possible connecting elements which are usually required in order to connect two separate spectacle lenses, for example as a nose bridge, can advantageously be dispensed with when using spectacles with a one-piece spectacle lens. Spectacles of this type can therefore, in particular when a plastic lens is used, be particularly light in construction, which further enhances the wear comfort of the spectacles because of its low weight.

In an alternative embodiment of spectacles in accordance with the invention, two separate spectacle lenses may be provided, wherein the left and the right spectacle lens section in this variation are configured as separate spectacle lenses which preferably are connected together with at least one intermediate nose bridge.

This variational embodiment with two separated spectacle lenses which are separate from each other and which may be connected together with one or more nose bridges which are themselves usual have the advantage of also being able to combine more elegant, less sporty spectacles with the particularly comfortable freely swinging nose pads of the damping elements. Optionally, the two separate spectacle lenses may also have a spectacle frame at least in sections. In this manner, there are no limits to the design possibilities as regards designs which combine with the elastically flexible damping elements on the underside of the spectacle lenses.

In a further advantageous embodiment, in spectacles in accordance with the invention, the left frame part and the right frame part may be configured as separate frame parts, preferably as separate mirror-symmetrical frame parts. In this variational embodiment, the two frame parts are separately fastened to the mutually opposing lateral ends of the respective spectacle lens section. The two frame parts are only connected together by means of the intermediate at least one spectacle lens. Connecting or nose bridges in the region of the upper edge of the spectacle lens are not necessary. Advantageously in this embodiment, the weight of the spectacles can be further reduced. In addition, removal and replacement of the mutually separate left and right frame parts from at least one spectacle lens is particularly simple in this variation.

Particularly preferably, in spectacles in accordance with the invention, the frame parts are exclusively fastened to the lateral ends of the respective spectacle lens sections or spectacle lenses. In this embodiment, the dimensions of the fastening sections on the frame parts for fastening the spectacle lens section can be particularly small. In the extreme case, the fastening sections on the frame parts could be punctiform. Particularly compact fastening of the spectacle lens or spectacle lenses of this type to the frame parts leads to a further reduction in the weight of the spectacles because less material is used for the frame parts.

In a further advantageous embodiment of the spectacles in accordance with the invention, in a wearing position in the neutral position of the spectacles, the damping elements do not come into contact with the respective spectacle lens sections or spectacle lenses. In this embodiment, the damping elements are separated from the lower edges or from the lower contour lines of the at least one spectacle lens by such a distance that in a wearing position of the spectacles on the user's head, they do not come into contact with the at least one spectacle lens. Advantageously again, the nasal frame ends adjacent to the damping elements together with the nose pads disposed thereon are correspondingly separated from the lower edges or from the lower contour lines of the at least one spectacle lens. Depending on the geometry of the embodiment and the selected distances between the respective damping element and the lower edge of the lens, this condition may not only be met in an unstressed wearing position in the neutral position, i.e. when the spectacles are being worn in a calm, vibration-free manner, but also in a stressed wearing position when an external force is applied, such as an impulse as a result of vibration of the spectacles.

In a further development of the invention, in the spectacles, the frame parts are connected together at their nasal frame ends to a central piece, preferably to an elastic central piece. This embodiment has the advantage that the two nasal frame ends with the nose pads disposed thereon do not form any free ends, but are movably connected together by means of a central piece in as elastic a manner as possible. Particularly in the case of sport spectacles, this embodiment offers the advantage of a reduced risk of injury, because the connecting central piece protects the two nasal frame ends in the manner of a protective hoop. In the event of particularly severe vibrations on the spectacles, a central piece of this type moreover secures the position of the nose pads on the nose of the user and reduces the risk of inadvertent shifting of the nose pads. A further advantage of this variational embodiment which may be mentioned is that on the connecting central piece, an optical clip-on, for example, i.e. an additional lens with an optical vision correction, may be clipped on. Similarly, for example, a tinted, darkened additional lens could be clipped onto the central piece.

In a particularly robust embodiment of the spectacles in accordance with the invention, the frame parts and/or the elastically flexible damping elements may be produced from a material which has a tensile modulus of elasticity of 1200 to 7000 MPa, preferably 1400 to 3500 MPa, in particular 1600 MPa.

The value for the tensile modulus of elasticity expresses the ratio between the tensile stress and the tensile strain of a material, in particular a plastic material. The Young's modulus or modulus of elasticity provides information regarding the stiffness of a material; the higher it is, the smaller is the deformation undergone by a specimen under a specific load.

Advantageously, in spectacles in accordance with the invention, the frame parts and/or the elastically flexible damping elements may be produced from a particularly dimensionally stable material which has a yield strength of 30 to 130 MPa, preferably 40 to 100 MPa, in particular 60 MPa. In plastics, the yield strength serves to determine the tensile properties and gives the first value of the tension for which an increase in strain occurs without increasing the tension. In plastics, tensions below the yield strength can also bring about a permanent deformation. A high yield strength indicates a strong, solid material.

Advantageously, in spectacles in accordance with the invention, the frame parts and/or the elastically flexible damping elements may be produced from a dimensionally stable material which has an elongation of 2% to 8%, preferably 3% to 7%, in particular 6%.

In a further particularly durable embodiment of the spectacles in accordance with the invention, the frame parts and/or the elastically flexible damping elements may be produced from an unbreakable material which has a breaking strength of 30 to 120 MPa, preferably 45 to 60 MPa.

Particularly robust spectacles may be produced when the frame parts and/or the elastically flexible damping elements are produced from an unbreakable material which has an elongation at break of more than 2%, preferably more than 10%, in particular more than 50%.

The following plastics which have one or more of the material properties discussed above may be mentioned by way of example: high performance plastics such as polyetherimides or polyamides, as well as ABS plastics.

Examples of polyetherimides (abbreviated to: PEI), which are polyimides, which may be mentioned are plastics which are commercially available under the trade names Ultem®, for example in the variations Ultem® 1000 or Ultem® 2300.

Acrylonitrile-butadiene-styrene copolymers (abbreviated to: ABS) are comparatively inexpensive plastics which may be used for the production of frame parts and/or elastically flexible damping elements because of their high impact strength and high notched impact strength and also their high stiffness.

Advantageously, in spectacles in accordance with the invention, the frame parts and/or the elastically flexible damping elements may be produced from a weather-resistant polyamide plastic, preferably from a cycloaliphatic polyamide plastic.

The description “polyamides” is usually used to describe synthetic thermoplastic plastics which can be used in engineering. Polyamides are often used as construction materials because of their superb strength and toughness.

Preliminary investigations have shown that transparent polyamide plastics which are produced by EMS-GRIVORY under the trade names Grilamid TR® and are freely available commercially, are particularly advantageous materials for the production of the frame parts and/or the elastically flexible damping elements. Compared with other transparent polymers, Grilamid TR® has a considerably low density. It is the lightest technical thermoplastic.

In particular, the polyamide plastic with the trade name Grilamid TR 90® has been shown to be particularly advantageous for use as a material for the frame parts and/or the elastically flexible damping elements. Grilamid TR 90® is a homopolyamide and has extremely good dynamic strength: this material has a fatigue strength of more than 30 MPa and even at a reversed bending stress of ±50 MPa achieves a million reversed bending cycles under alternating load. The tensile modulus of elasticity of Grilamid TR 90® is 1600 MPa. The yield strength is approximately 60 MPa and the elongation is about 6%. Its nominal elongation at break is more than 50%, and so this material is also particularly tough. Moreover, the density of Grilamid TR 90® is only 1 g/cm³. Depending on the design of the spectacle frame or the frame parts, this selected material can be used to produce a frame means which is extremely light and in total weighs only 30 g.

In addition to the mechanical properties such as high strength, stiffness and ductility, this plastic has good chemical resistance against cosmetics, perspiration and various coatings. The plastic is free from plasticizers.

Usually, preferred materials for use in the production of the spectacles are thermoplastic polycarbonate plastics because these have a high strength, impact strength, stiffness and hardness. By means of suitable lacquer coatings or in laminates with transparent thermoplastic polyurethanes, lightweight, UV light-resistant glazing can be produced from polycarbonate which is highly suitable for spectacle lenses and also for optical lenses produced from plastic. As an alternative, other transparent plastics such as polymethylmethacrylate (abbreviated to: PMMA) may also be used for the production of the spectacle lens.

Particularly preferably, in the spectacles in accordance with the invention, in a wearing position on the user's head, starting from the respective fastening section, the resilient damping elements firstly extend in a direction opposite to the temple laterally downwardly on the head of the user and then in a nasal direction towards the nose of the user, so that in a wearing position of the spectacles, the damping elements respectively form a lower frame section for the at least one spectacle lens without being connected thereto. Advantageously, the damping elements in this variation may, for example, be curved or bent and substantially follow the contours of the lower as well as also at least a part of the lateral edge of the respective spectacle lens section without, however, being fastened to the spectacle lens. The larger the exposed length of the freely resilient or freely swinging damping element, the higher the damping action that can be obtained.

Starting from the fastening section, this lower frame section forms the continuation of the respective frame part, wherein the lower frame section is at a distance from the spectacle lenses and does not come into direct contact with the respective spectacle lenses. This lower frame section ends at the nose pads or at the respective nasal end of the resilient elements.

In order to guarantee a sufficient spring effect when stressed in the event of knocks or impacts on the spectacles, it may be advantageous in the spectacles in accordance with the invention for the resilient damping elements to respectively have a free swinging length of 60 to 100 mm, preferably of 70 to 90 mm.

When wearing the spectacles without stresses without the external application of knocks or vibrational forces, the distance between the lower rim of the at least one spectacle lens and the respective damping element is 2 mm, for example, and 3 mm for the nose pads, for example. In the stressed condition under the effect of an external force during vibration of the spectacles, the distance between the lower rim of the spectacle lens and the respective damping element or the respective nose pad can be reduced to ±0 mm. Depending on the individual anatomy of the user, if the nose of the spectacles wearer is slender, the situation might arise that the position of the nose pads in the wearing position viewed from the front lies in a plane behind the at least one spectacle lens. This means that during stress on the spectacles, i.e. in a stressed wearing position during an external application of force to the spectacles, the damping elements could swing in the vertical direction between the spectacle lens and the front of the face of the user even higher than up to the lower rim of the spectacle lens without touching the edges of the lenses thereby.

### BRIEF DESCRIPTION OF THE DRAWINGS

Further details, features and advantages of the invention will become apparent from the following description of exemplary embodiments which are diagrammatically shown in the drawings, in which:

FIG. 1 shows, in an isometric view from the front, a first embodiment in accordance with the invention of spectacles with a one-piece spectacle lens as well as with two frame parts fastened to the spectacle lens, wherein the nose pads are disposed on the free nasal frame ends of the damping elements;

FIG. 2 shows the spectacles shown in FIG. 1 in an exploded view from the front, with a left and a right frame part separated from the spectacle lens;

FIG. 2A shows a detailed view of the detail A marked with a dashed line in FIG. 2;

FIG. 3 shows a front view of the spectacles shown in FIG. 1 in an unstressed wearing position in the neutral position of the spectacles;

FIG. 4 shows a front view of the spectacles shown in FIG. 1 in a stressed wearing position when an external force is applied to the spectacles;

FIG. 5 shows a front view of a second embodiment in accordance with the invention of spectacles with a one-piece spectacle lens as well as with two frame parts fastened to the spectacle lens, wherein the nasal frame ends of the damping elements are connected to a central piece;

FIG. 6 shows a front view of a third embodiment in accordance with the invention of spectacles with two separate spectacle lenses which are connected together with nose bridges, as well as with two frame parts fastened to the respective spectacle lenses, wherein the nasal frame ends of the damping elements are connected to a central piece;

FIG. 7 shows, in front view, the spectacles shown in FIG. 3 in an unstressed wearing position in the neutral position of the spectacles, together with the contour of the head of an spectacles wearer, shown as a dashed line;

FIG. 8 shows, in front view, the spectacles shown in FIG. 4 in a stressed wearing position when an external force is applied to the spectacles, together with the contour of the head of an spectacles wearer, shown as a dashed line;

FIG. 9 shows, in side view, the spectacles shown in FIG. 7 in an unstressed wearing position in the neutral position of the spectacles, together with the contour of the head of an spectacles wearer, shown as a dashed line.

### DETAILED DESCRIPTION OF THE PREFERRED EMBODIMENTS

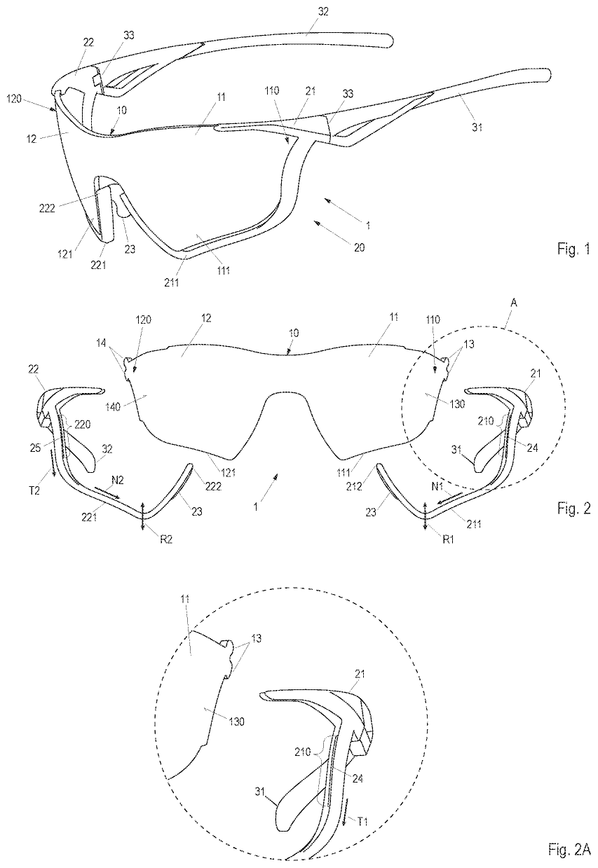

The following detailed description of the figures refers to the first embodiment in accordance with the invention of spectacles 1 shown in FIGS. 1 to 4. The spectacles 1 shown here are designed as sport spectacles and have a one-piece continuous spectacle lens 10 produced from an unbreakable plastic. The spectacle lens 10 has a left spectacle lens section 11 as well as a right spectacle lens section 12. Keying portions 13, 130 are formed on a lateral end 110 of the left spectacle lens section 11 which serve for mechanical fastening to a frame means 20 or to a corresponding left frame part 21. A lower edge 111 of the left spectacle lens section 11 forms a contour section of the spectacle lens.

As a mirror image thereof, the right spectacle lens section 12 has a lateral end 120 on which the keying portions 14, 140 are formed, which serve for mechanical fastening to a frame means 20 or to a corresponding right frame part 22. A lower edge 121 of the right spectacle lens section 12 forms a contour section of the spectacle lens.

The frame means 20 comprises a left frame part 21 with a left fastening section 210, a left damping element 211 fastened thereto as well as a left nasal frame end 212.

Furthermore, the frame means 20 comprises a separate right frame part 22 which is independent of the left frame part 21, having a right fastening section 220, a right damping element 221 fastened thereto as well as a right nasal frame end 222. The left 21 and the right 22 frame parts are mirror-symmetrical in design and, for example, are formed in one piece from a thermoplastic with the trade name Grilamid TR 90®. A respective nose pad 23 is fastened to each of the nasal frame ends 212. Particularly advantageously, these nose pads 23 are equipped with an inner insert material, for example produced from a metal, which can easily be shaped by a user. In this manner, the nose pads 23 can be tailored to the respective anatomy of the nose of the user. The left fastening section 210 has a left fastening recess 24, into which fastening recess 24 the keying portions 13, 130 or contour sections disposed on the lateral end 110 of the left spectacle lens section 11 engage in the assembled state of the spectacles 1. Here, an interlocking and frictional releasable push fit connection is selected in order to connect the left frame part 21 to the corresponding spectacle lens section 11 of the spectacle lens 10.

Similarly, the right fastening section 220 has a right fastening recess 25 into which fastening recess 25 the keying portions 14, 140 or contour sections at the lateral end 120 of the right spectacle lens section 12 engage in the assembled state of the spectacles 1. Here again—mirror symmetrically—an interlocking and frictional releasable push fit connection is selected in order to connect the right frame part 22 to the corresponding spectacle lens section 12 of the spectacle lens 10. In the assembled state of the spectacles 1, the two frame parts 21, 22 are only connected together with the intermediate spectacle lens 10.

On the two frame parts 21, 22, in pairs, a left spectacle side piece 31 as well as a right spectacle side piece 32 are respectively movably fastened by means of side piece hinges 33. The arrow N1 symbolises the nasal direction N1 of the left damping element 211—with respect to the envisaged wearing position of the spectacles on the head of a user, it is “towards the nose of the user”. The arrow N2 symbolises the nasal direction N2 of the right damping element 221. The variable clearance gap S1 between the left damping element 211 and the lower lens edge 111 is indicated by an arrow S1. Similarly, the variable clearance gap S2 between the right damping element 221 and the corresponding lower lens edge 121 is indicated by an arrow S1.

A deflection direction R1 of the left damping element 211 in which it can swing freely is symbolised by a double headed arrow R1.

A deflection direction R2 in which the right damping element 221 can swing freely is symbolised by a double headed arrow R2.

In the embodiment shown here, the respective damping element 211, 221 extends not only in the nasal direction N1, N2 substantially along the lower rim 111, 121 of the spectacle lens 10, but also follows the lateral curve of the spectacle lens 10 in the temple or lateral direction T1, T2 to the respective fastening section 210, 220. The arrow T1 symbolises the lateral direction of the free position of the left damping element 211. Using the anatomical term “temple” to mean “leading towards the temples of a user”, the left damping element 211—starting from the fastening section 210—goes firstly in the direction of the arrow T1 in a lateral direction, strictly speaking in a direction away from the temple of the user, laterally downwardly, in order to subsequently follow the curved or rounded contour of the spectacle lens 10 and extend in the nasal direction N1.

Reciprocally, the arrow T2 symbolises the lateral direction of the free position of the right damping element 221. The right damping element 221 too—starting from the fastening section 220—is initially orientated in the arrow direction T2—laterally downwardly in a lateral direction away from the temple of the user in order to subsequently follow the curved or rounded contour of the spectacle lens 10 and extend in the nasal direction N2.

In an unstressed wearing position P1 in the neutral position of the spectacles 1, as can be seen in FIG. 3, for example, the clearance gaps S1, S2 between the lower rims 111, 121 of the spectacle lens 10 and the respective damping element 211, 221, are 2 mm, for example, and 3 mm, for example, in the region between the lower edges 111, 121 and the nose pads 23.

In the stressed condition when an external force P2 is applied, as illustrated in FIG. 4 by way of example, during vibration of the spectacles 1, the clearance gaps S1, S2 between the lower rims 111, 121 of the spectacle lens 10 and the respective damping elements 211, 221 or the respective nose pads 23, could be reduced to ±0 mm. Advantageously, the clearance gaps S1, S2 are variable, whence even external applied forces P2 which do not act centrally from above on the spectacles 1 but, for example, are in the form of forces applied from the side or obliquely from above or from below, can be absorbed particularly effectively by the elastic damping elements 211, 221. As an example, in a stressed wearing position P2 in which the external force acts on the spectacles 1 primarily on the left frame part 21, the left clearance gap S1 is briefly substantially smaller than the right clearance gap S2. The two damping elements 211, 221 may advantageously be deflected independently of each other in order to be able to absorb vibrations on the spectacles 1 to the best possible extent and in this manner to ensure good wearing comfort for the spectacles wearer.

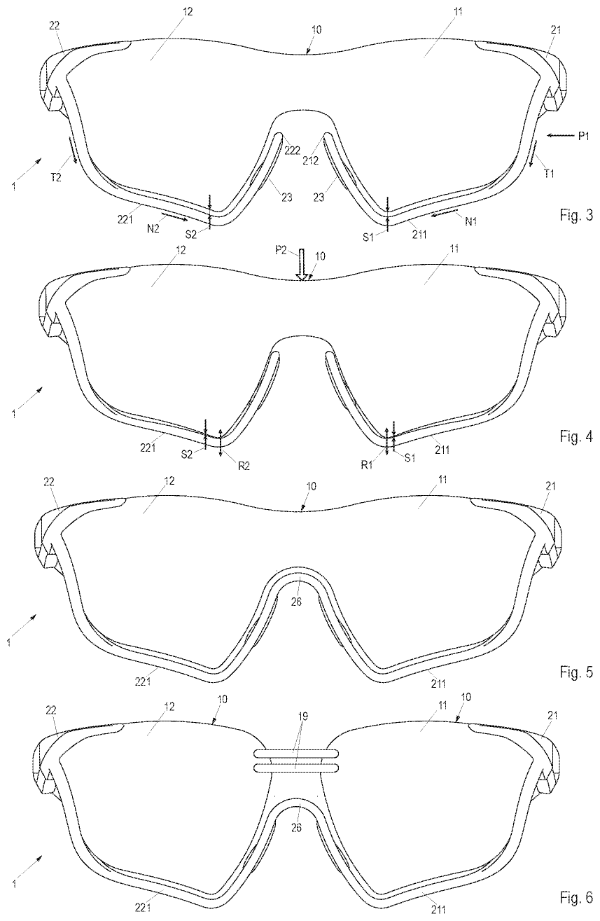

FIG. 5 shows a second embodiment in accordance with the invention of spectacles 1 with a one-piece spectacle lens 10 as well as with two frame parts 21, 22 fastened to the spectacle lens 10, wherein the nasal frame ends 212, 222 of the damping elements 211, 221 are connected to an elastic central piece 26. The elastic central piece 26 here is, for example, a soft silicone tube section which is fastened to the nasal frame ends 212, 222 and which enables the sport spectacles to be held in a particularly secure, non-slip manner in the wearing position on the head of a user.

FIG. 6 shows a third embodiment of spectacles 1 in accordance with the invention with two separate spectacle lenses 11, 12 which are connected together by means of two nose bridges 19. Respective frame parts 21, 22 are fastened to the spectacle lenses 11, 12, wherein the nasal frame ends 212, 222 of the damping elements 211, 221 are connected to a central piece 26.

Similarly, in a further embodiment which is not explicitly shown of spectacles 1 in accordance with the invention with two separate spectacle lenses 11, 12, a central piece 26 of this type may be omitted. In this variation of the design, conventional spectacles 1 with separate spectacle lenses 11, 12 can be combined with the advantageous effects of the frame parts 21, 22 provided with the damping elements 211, 221.

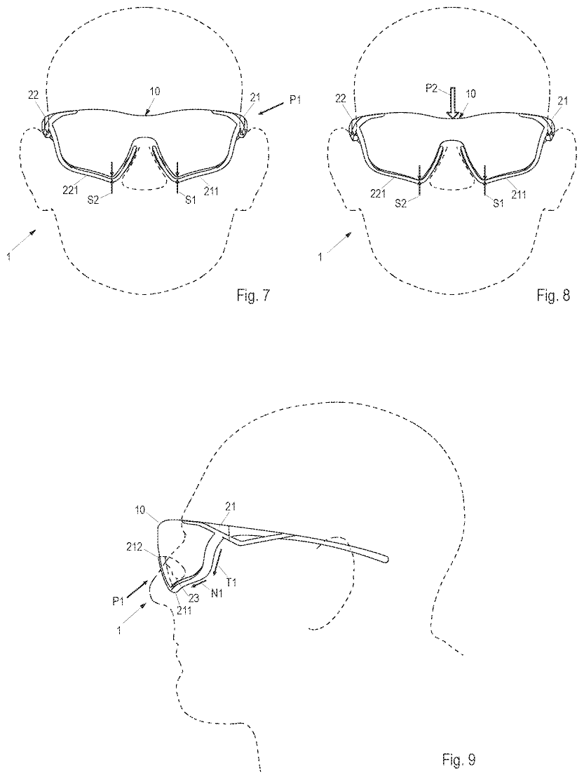

FIG. 7 shows the spectacles 1 shown in FIG. 3 in an unstressed wearing position P1 in the neutral position of the spectacles 1 together with the contour, shown in dashed lines, of the head of the spectacles wearer. The clearance gaps S1, S2 here are between 2 mm and 3 mm, for example, in the unstressed wearing position.

FIG. 8 shows the spectacles 1 shown in FIG. 4 in a stressed wearing position P2 during application of an external force which is symbolised by arrow P2, together with the contour of the head of the spectacles wearer, shown in dashed lines. Here, the clearance gaps S1, S2 in the stressed wearing position are briefly ±0 mm viewed from the front. Because the nose of the spectacles wearer is comparatively narrow and slender, the nose pads 23 here are curved slightly backwards with respect to the wearer's face behind the spectacle lens 10 on the nose. This can also be seen in the side view of FIG. 9. In this manner, in the stressed wearing position P2 of FIG. 8, the damping elements 211, 221 as well as the nose pads 23 do not come into contact with the lower edges 111, 121 of the spectacle lens 10 even during application of the external force P2.

### LIST OF REFERENCE NUMERALS

1 spectacles
10 spectacle lens
11 left spectacle lens section or left spectacle lens
12 right spectacle lens section or right spectacle lens
110 lateral end of spectacle lens section
111 lower edge of left spectacle lens section
120 lateral end of right spectacle lens section
121 lower edge of right spectacle lens section
13, 130 keying portion of left spectacle lens
14, 140 keying portion of right spectacle lens
19 nose bridge
20 frame means
21 left frame part
210 left fastening section
211 left damping element
212 left nasal frame end
22 right frame part
220 right fastening section
221 right damping element
222 right nasal frame end
23 nose pad
24 left fastening recess
25 right fastening recess
26 central piece
31 left spectacle side piece
32 right spectacle side piece
33 side hinge
N1 nasal direction of left damping elements (arrow)
N2 nasal direction of right damping elements (arrow)
S1 clearance gap between left damping element and lower lens edge (arrow)
S2 clearance gap between right damping element and lower lens edge (arrow)
P1 unstressed wearing position in neutral position of spectacles
P2 stressed wearing position during application of a force to the spectacles (arrow)
R1 deflection direction of left damping elements (arrow)
R2 deflection direction of right damping elements (arrow)
T1 temple direction of left damping elements (arrow)
T2 temple direction of right damping elements (arrow)

1. Spectacles comprising at least one spectacle lens with a left and a right spectacle lens section, a frame means which comprises a left and a right frame part, wherein the frame means is in mechanical engagement with the at least one spectacle lens and the left frame part is associated with the left spectacle lens section and also the right frame part is associated with the right spectacle lens section, wherein each frame part has a fastening section with a fastening recess, into which fastening recess at least one keying portion disposed at a lateral end of the respective spectacle lens section engages, characterized in that each frame part has a respective elastically flexible damping element, wherein each damping element is fastened to a respective fastening section and extends in a nasal direction of the spectacles along a lower edge of the respective spectacle lens section and is also separated from the lower edge with the formation of a variable clearance gap, up to a nasal end of the frame, wherein each damping element can be elastically flexibly deflected in at least one direction, and wherein a respective nose pad is disposed on each of the nasal frame ends, the nose pad being configured to sit on the nose of a user in a wearing position of the spectacles and to support the respective frame part.

2. The spectacles as claimed in claim 1, wherein the spectacle lens is produced in one piece and the left and the right spectacle lens section are connected together.

3. The spectacles as claimed in claim 1, wherein two separate spectacle lenses are provided, wherein the left and the right spectacle lens section are configured as separate spectacle lenses which are preferably connected together with at least one intermediate nose bridge.

4. The spectacles as claimed in claim 1, wherein the left and the right frame part are configured as separate frame parts, preferably as separate mirror-symmetrical frame parts.

5. The spectacles as claimed in claim 1, wherein the frame parts are exclusively fastened to the lateral ends of the respective spectacle lens sections or spectacle lenses.

6. The spectacles as claimed in claim 1, wherein in a wearing position in a neutral position of the spectacles, the damping elements do not come into contact with the respective spectacle lens sections or spectacle lenses.

7. The spectacles as claimed in claim 1, wherein the frame parts are connected together at their nasal frame ends to a central piece, preferably to an elastic central piece.

8. The spectacles as claimed in claim 1, wherein the frame parts and/or the elastically flexible damping elements are produced from a material which has a tensile modulus of elasticity of 1200 to 7000 MPa, preferably 1400 to 3500 MPa, in particular 1600 MPa.

9. The spectacles as claimed in claim 1, wherein the frame parts and/or the elastically flexible damping elements are produced from a material which has a yield strength of 30 to 130 MPa, preferably 40 to 100 MPa, in particular 60 MPa.

10. The spectacles as claimed in claim 1, wherein the frame parts and/or the elastically flexible damping elements are produced from a material which has an elongation of 2% to 8%, preferably 3% to 7%, in particular 6%.

11. The spectacles as claimed in claim 1, wherein the frame parts and/or the elastically flexible damping elements are produced from a material which has a breaking strength of 30 to 120 MPa, preferably 40 to 60 MPa.

12. The spectacles as claimed in claim 1, wherein the frame parts and/or the elastically flexible damping elements are produced from a material which has an elongation at break of more than 2%, preferably more than 10%, in particular more than 50%.

13. The spectacles as claimed in claim 1, wherein the frame parts and/or the elastically flexible damping elements are produced from a weather-resistant polyamide plastic, preferably from a cycloaliphatic polyamide plastic.

14. The spectacles as claimed in claim 1, wherein in a wearing position of the spectacles on a user's head, starting from the respective fastening section, the elastically flexible damping elements firstly extend in a direction opposite to a temple laterally downwardly on the head of the user and then in a nasal direction towards the nose of the user so that the damping elements respectively form a lower frame section.

15. The spectacles as claimed in claim 1, wherein the elastically flexible damping elements respectively have a free swinging length of 60 to 100 mm, preferably of 70 to 90 mm.
